(19) United States
(12) Patent Application Publication
(10) Pub. No.: US 2022/0353642 A1
(43) Pub. Date: Nov. 3, 2022

(54) Dynamic Switch Between Multicast and Unicast for NR Multicast Service

(71) Applicant: MediaTek Singapore Pte. Ltd., Singapore (SG)

(72) Inventor: Xuelong Wang, Beijing (CN)

(21) Appl. No.: 17/812,568

(22) Filed: Jul. 14, 2022

Related U.S. Application Data
(63) Continuation of application No. PCT/CN2021/072234, filed on Jan. 15, 2021.
Application No. PCT/CN2021/072234 is a continuation of application No. PCT/CN2020/072215, filed on Jan. 15, 2020.

(30) Foreign Application Priority Data
Jan. 15, 2020 (CN) PCT/CN2020/072215
Jan. 15, 2021 (CN) PCT/CN2021/072234

(51) Int. Cl. H04W 4/06; H04W 76/40

(52) U.S. Cl. CPC H04W 4/06; H04W 76/40

(57) ABSTRACT

Apparatus and methods are provided for dynamic switch between multicast and unicast for the NR multicast service. In one novel aspect, the network determines to perform the multicast-to-unicast switch or the unicast-to-multicast switch based on one or more predefined criteria. The switch order is sent from the gNB to the UE via specific MAC-CE or RRC Reconfiguration message, which includes the switch type, the logical channel ID of the previous RB, the logical channel ID of the newly established RB channel. The UE reconfigures the RB for the multicast services. The UE receives buffered and/or unacknowledged data, and new data packets for the multicast service. In one embodiment, a temporary unicast DRB is established for the buffered and/or unacknowledged data. The UE sends feedback information to the gNB with information of the next expected data packet.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2021/072234, titled “Dynamic Switch Between Multicast and Unicast for NR Multicast Service,” with an international filing date of Jan. 15, 2021. International application No. PCT/CN2021/072234, in turn, claims priority under 35 U.S.C. § 120 and § 365(c) from International Application No. PCT/CN2020/072215, titled “Methods and Apparatus of Dynamic Switch Between Multicast and Unicast for NR Multicast Service,” with an international filing date of Jan. 15, 2020. This application is a continuation of International Application No. PCT/CN2021/072234. International Application No. PCT/CN2021/072234 is pending as of the filing date of this application, and the United States is an elected state in International Application No. PCT/CN2021/072234. The disclosure of each of the foregoing documents is incorporated herein by reference.

### TECHNICAL FIELD

The disclosed embodiments relate generally to wireless communication, and, more particularly, to dynamic switch between multicast and unicast for new radio (NR) multicast service.

### BACKGROUND

With the exponential growth of wireless data services, the content delivery to large mobile user groups has grown rapidly. Initial wireless multicast/broadcast services include streaming services such as mobile TV and IPTV. With the growing demand for large group content delivery, recent application development for mobile multicast services requires highly robust and critical communication services such as group communication in disaster situations and the necessity of public safety network-related multicast services. The early 3GPP in the LTE standard defines enhanced multimedia broadcast multicast services eMBMS. The single-cell point to multipoint (SC-PTM) services and multicast-broadcast single-frequency network (MBSFN) are defined. The early multicast/broadcast services, such as mobile TV services, do not require ACK/NACK-based feedback for the multicast data packets. With the increasingly demand for multicast services for critical communication services such as involving disaster situations and public safety services, the necessity of a reliable multicast data delivery requires improvement of the existing mobile multicast/broadcast services. Currently, there is no support for dynamic switch between multicast and unicast for a multicast service. When the network condition and/or usage condition changes, it is desired to switch from the multicast mode to the unicast mode or vice versa.

Improvements and enhancements are required to provide solutions for dynamic switching between multicast and unicast for multicast services in a NR wireless network.

### SUMMARY

Apparatus and methods are provided for dynamic switch between multicast and unicast for the NR multicast service. In one novel aspect, the network determines to perform the multicast-to-unicast switch or the unicast-to-multicast switch based on one or more predefined criteria. The switch order is sent from the gNB to the UE via specific MAC-CE or RRC Reconfiguration message, which includes the switch type, the logical channel ID of the previous RB, the logical channel ID of the newly established RB channel. The UE reconfigures the RB for the multicast services. The UE receives buffered and/or unacknowledged data, and new data packets for the multicast service. In one embodiment, a temporary unicast DRB is established for the buffered and/or unacknowledged data. The UE sends feedback information to the gNB with information of the next expected data packet.

In one embodiment, the UE receives a multicast service in the NR network, wherein each data packet for the multicast service has PDCP PDU SN, receives a switch order of the multicast service from the NR network, wherein the switch over order indicates to switch from a multicast to a unicast when the multicast service is received by a MRB and from a unicast to a multicast when the multicast service is received by a unicast DRB, reconfigures a receiving radio bearer for the multicast service based on the switch order, and receives the multicast data packets for the multicast service on the reconfigured receiving RB with continuous numbering of PDCP PDU SN for the multicast service. In one embodiment, the switch order indicates to switch from multicast to unicast for the multicast service, and wherein a new unicast DRB is established for the multicast service. In another embodiment, the switch order is a MAC control element (CE) of switch over including one or more elements comprising a switch type, a logic channel identification (LCID) of the MRB, an LCID of the unicast DRB, and an LCID of a temporary DRB. In one embodiment, the UE acknowledges the switch order by a specific MAC CE of switch order confirm including information of a next expected data packet of one or more data types comprising a PDCP PDU, a RLC PDU, and a RLC segment. In another embodiment, the switch order is a radio resource control (RRC) message of switch order including one or more elements comprising a switch type, a logic channel identification (LCID) of the MRB, an LCID of the unicast DRB, an LCID of a temporary DRB, and security configuration of the new unicast DRB. In one embodiment, the UE acknowledges the switch order by a RRC message of switch order confirm including information of a next expected data packet of one or more data types comprising a PDCP PDU, a RLC PDU, and a RLC segment. In another embodiment, the new unicast DRB receives unacknowledged and buffered multicast data packets for the MRB and new multicast data packets for the unicast DRB. In yet another embodiment, the switch order indicates to switch from unicast to multicast for the multicast service, and wherein a new MRB is established for the multicast service. In one embodiment, the new MRB starts with a multicast data packet with an SN of a last non-acknowledged PDCP packet. In another embodiment, multiple UEs are switched to multicast for the multicast service, the new MRB starts with a multicast data packet with an SN of a lowest value among all UEs switched for the multicast service.

In one embodiment, the gNB provides a multicast service to a UE in the NR network, wherein each data packet for the multicast service has PDCP PDU SN, sends a switch order of the multicast service to the UE, wherein the switch over order indicates to switch from a multicast to a unicast when the multicast service is received by a MRB and from a unicast to a multicast when the multicast service is received by a unicast DRB, reconfigures a transmitting radio bearer for the multicast service based on the switch order, and transmits multicast data packets to the UE for the multicast service on the reconfigured transmitting RB with continuous numbering of PDCP PDU SN for the multicast service. In one embodiment, the new unicast DRB transmits buffered multicast data packets, unacknowledged multicast data packets, and new multicast data packets. In another embodiment, a temporary DRB is established for buffered multicast data packets, unacknowledged multicast data packets. In one embodiment, the temporary DRB has a same logic channel ID (LCID) as the MRB and the new unicast DRB has a different LCID from the MRB.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary NR wireless network that supports dynamic switch between multicast and unicast in accordance with embodiments of the current invention.

FIG. 2 illustrates an exemplary NR wireless system with centralized upper layers of the NR radio interface stacks and UE stack with multicast protocol and unicast protocol in accordance with embodiments of the current invention.

FIG. 3 illustrates exemplary diagrams of the multicast-to-unicast switch over procedure for the multicast radio bearer in accordance with embodiments of the current invention.

FIG. 4 illustrates exemplary flow diagrams for multicast-to-unicast signaling in accordance with embodiments of the current invention.

FIG. 5 illustrates exemplary flow diagrams for unicast-to-multicast signaling in accordance with embodiments of the current invention.

FIG. 6 illustrates an exemplary flow chart of the UE performing the dynamic switch between the multicast and the unicast for NR multicast services in accordance with embodiments of the current invention.

FIG. 7 illustrates an exemplary flow chart of the base station/gNB performing the dynamic switch between the multicast and the unicast for NR multicast services in accordance with embodiments of the current invention.

### DETAILED DESCRIPTION

Reference will now be made in detail to some embodiments of the invention, examples of which are illustrated in the accompanying drawings.

3GPP specified the basic eMBMS with the focus on multicast-broadcast single-frequency network (MBSFN). Both MBSFN and SC-PTM transmission are supported based on the dedicated MBMS system architecture, where a multi-call/multicast coordination entity (MCE) is located between radio access network (RAN) and core network (CN). MCE is responsible for the determination of the transmission mode of MBSFN or SC-PTM. Both the MBSFN and SC-PTM rely on the specific MBMS radio bearer. In LTE SC-PTM is characterized by that MBMS is transmitted in the coverage of a single cell. One SC-multicast control channel (MCCH) and one or more SC-multicast traffic channels (MTCHs) are mapped on downlink shared channel (DL-SCH). The scheduling is done by the base station. The SC-MCCH and SC-MTCH transmissions are each indicated by a logical channel specific radio network temporary identifier (RNTI) on physical downlink control channel (PDCCH) A one-to-one mapping is configured between temporary mobile group identity (TMGI) and group RNTI (G-RNTI) used for the reception of the DL-SCH to which a SC-MTCH is mapped. A single transmission is used for DL-SCH on which SC-MCCH or SC-MTCH is mapped. Neither blind HARQ repetitions nor RLC quick repeat is configured for mapped DL-SCH. With the rapid growth of the multicast services in the NR network, dynamic switch between multicast and unicast is a key feature to support new multicast services.

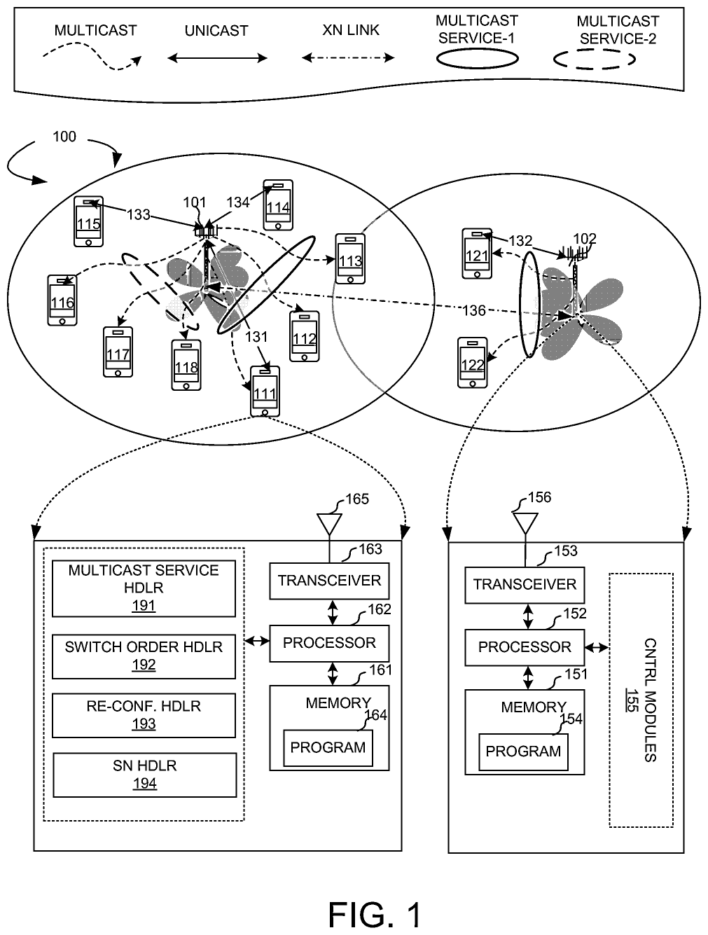

FIG. 1 is a schematic system diagram illustrating an exemplary NR wireless network that supports dynamic switch between multicast and unicast in accordance with embodiments of the current invention. NR wireless system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be homogeneous network or heterogeneous network, which can be deployed with the same frequency or different frequency. gNB 101 and gNB 102 are base stations in the NR network, the serving area of which may or may not overlap with each other. The backhaul connection such as 136, connects the non-co-located receiving base units, such as gNB 101 and gNB 102. These backhaul connections can be either ideal or non-ideal. gNB 101 connects with gNB 102 via Xnr interface.

NR wireless network 100 also includes multiple communication devices or mobile stations, such user equipments (UEs) such as UEs 111, 112, 113, 114, 116, 117, 121 and 122. The exemplary mobile devices in wireless network 100 have sidelink capabilities. The mobile devices can establish one or more unicast connections with one or more base stations. For example, UE 111 has unicast connection 131 with gNB 101. UEs 114 and 115 connect with gNB 101 with unicast connections 133 and 134, respectively. Similarly, UEs 121 connects with gNB 102 with unicast connection 132.

In one novel aspect, the lossless switch between the multicast transmission and the unicast transmission for a multicast service is supported. The multicast data packets between the multicast mode and the unicast mode are continuous. A multicast service-1 is provided by gNB 101 and gNB 102. UEs 111, 112 and 113 receive multicast services from gNB 101. UEs 121 and 122 receive multicast services from gNB 102. Multicast service-2 is provided by gNB 101 to the UE group of UEs 116, 117, and 118. Multicast service-1 and multicast service-2 are delivered in multicast mode with a multicast radio bearer (MRB) configured by the NR wireless network. The receiving UEs receives data packets of the multicast service through corresponding MRB configured. In one embodiment, the base station, such as gNB 101 and gNB 102, determines to switch from multicast to unicast for one or more multicast services. For example, gNB 101 determines to switch multicast service-1 from multicast to unicast. A switch over message is sent to the UEs receiving the multicast services. In another embodiment, when a multicast service is delivered with a unicast mode, the base station, such as gNB 101 and gNB 102, determines to switch over from the unicast mode to the multicast mode for a multicast service, such as multicast service-1. In one embodiment, packet data convergency protocol (PDCP) packet data unit (PDU) has sequence number (SN) for multicast data packets. The switch over between the multicast and the unicast are lossless switch over such that the multicast data packets are not lost during the switch over.

FIG. 1 further illustrates simplified block diagrams of a base station and a mobile device/UE for adaptation handling for L2-based sidelink relay. gNB 102 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 102. Memory 151 stores program instructions and data 154 to control the operations of gNB 102. gNB 102 also includes a set of control modules 155 that carry out functional tasks to communicate with mobile stations.

FIG. 1 also includes simplified block diagrams of a relay UE, such as UE 111. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for HF transmitting and receiving, and the other RF module is used for different frequency bands transmitting and receiving which is different from the HF transceiver. RF transceiver 163 also converts received baseband signals from processor 162, converts them to RF signals, and sends out to antenna 165. Processor 162 processes the received baseband signals and invokes different functional modules to perform features in the UE 111. Memory 161 stores program instructions and data 164 to control the operations of the UE 111. Antenna 165 sends uplink transmission and receives downlink transmissions to/from antenna 156 of gNB 102.

The UE also includes a set of control modules that carry out functional tasks. These control modules can be implemented by circuits, software, firmware, or a combination of them. A multicast service handler 191 receives a multicast service by a user equipment (UE) in a new radio (NR) network, wherein each data packet for the multicast service has packet data convergence protocol (PDCP) packet data unit (PDU) sequence number (SN). A switch order handler 192 receives a switch order of the multicast service from the NR network, wherein the switch over order indicates to switch from a multicast to a unicast when the multicast service is received by a multicast radio bearer (MRB) and from a unicast to a multicast when the multicast service is received by a unicast dedicated radio bearer (DRB). A reconfiguration handler 193 reconfigures a receiving radio bearer for the multicast service based on the switch order. An SN handler 194 receives the multicast data packets for the multicast service on the reconfigured receiving RB with continuous numbering of PDCP PDU SN for the multicast service.

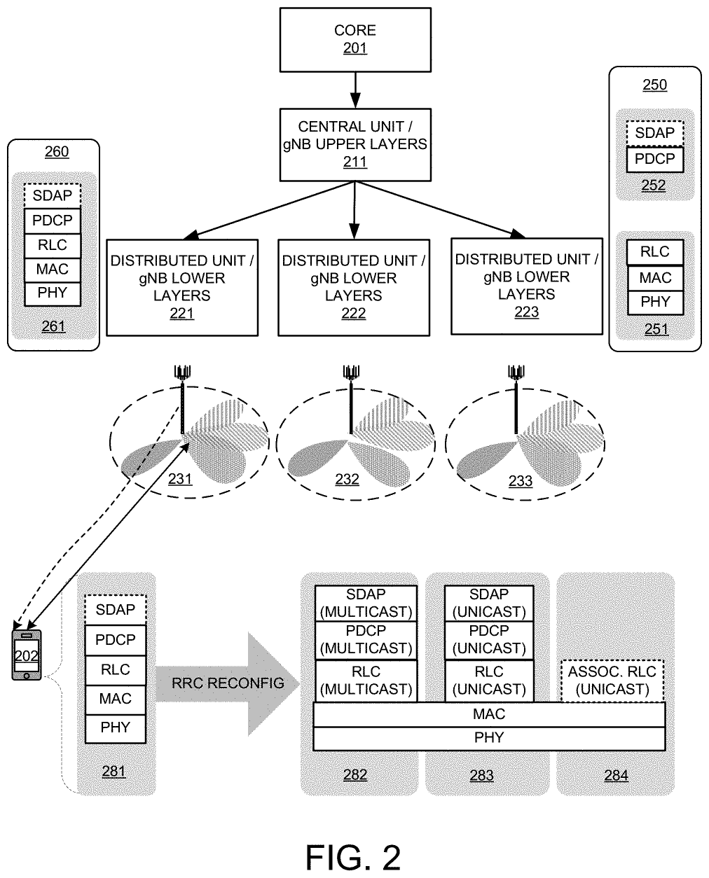

FIG. 2 illustrates an exemplary NR wireless system with centralized upper layers of the NR radio interface stacks and UE stack with multicast protocol and unicast protocol in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization and jitter. In one embodiment, SDAP and PDCP layer are located in the CU, while RLC, MAC and PHY layers are located in the DU. A core unit 201 is connected with one central unit 211 with gNB upper layer 252. In one embodiment 250, gNB upper layer 252 includes the PDCP layer and optionally the SDAP layer. Central unit 211 connects with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the RLC layers. In another embodiment 260, each gNB has the protocol stacks 261 including SDAP, PDCP, RLC, MAC and PHY layers.

Similarly, a UE 202 has a protocol stack 281 including the PHY, MAC, RLC, PDCP, and optional SDAP layers. For RRC_CONNECTED mode UE, the multicast radio bearer (MRB) 282 is added through RRC reconfiguration for a multicast service when the UE initiates the joining procedure at the upper layers. The base station is notified by the CN the start of the corresponding session. When the multicast PDU session starts, a QoS flow is created by the gNB, and a SDAP entity is also created to map the flow to a specific MRB. To establish a corresponding MRB, a PDCP entity is created with specific security configuration. An RLC entity is also created. The MAC configuration is configured with a specific multicast logical channel (MTCH). A new LCID is allocated for this new MTCH. In one embodiment, a portion of the LCID field is reserved for the MTCH at MAC layer. The configuration of SDAP/PDCP/RLC/MAC is sent to UE during RRC Reconfiguration procedure for this MRB. The UE establishes the MRB and sends the RRC Reconfiguration Complete message to the gNB. The security configuration of MRB can be enforced by PDCP. Alternatively, there is no security configuration for MRB. The security is enforced at upper layer or service application layer. When the security configurations, such as the ciphering and/or integrity protection of MRB is enforced by PDCP entity, the security configuration of PDCP entity is common for all the UEs receiving the multicast services. The same robust header compression (ROHC) configuration and selected ROHC mode are applicable to all the UEs receiving the multicast service.

In one embodiment, a unicast stack 283 is established for a switch over procedure for the multicast service. When the switch over from the multicast to the unicast procedure is initiated, unicast stack 283 is established to receive the packet data of the multicast service received in the unicast mode. In one embodiment, an associated RLC protocol stack 284 is established for the switch over procedure.

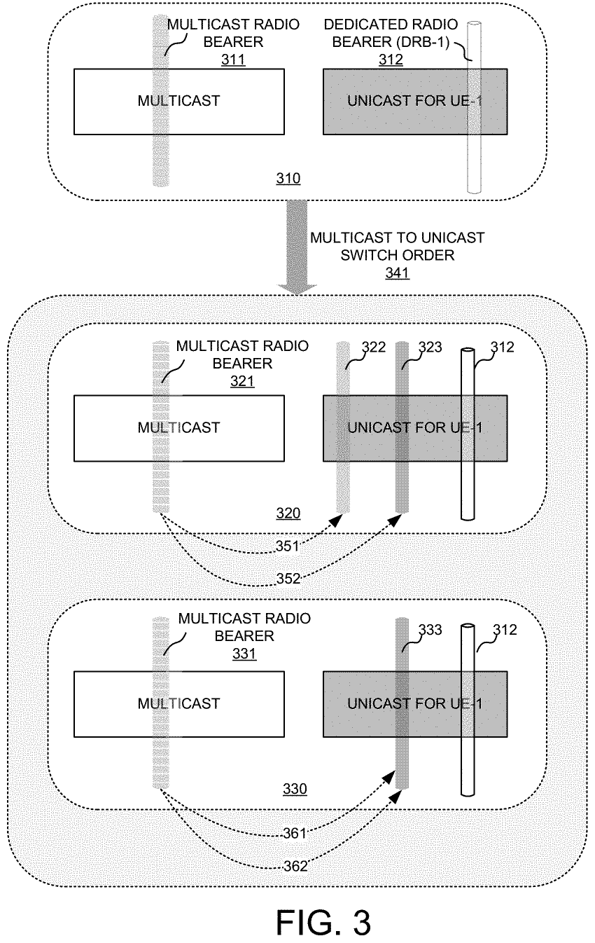

FIG. 3 illustrates exemplary diagrams of the multicast-to-unicast switch over procedure for the multicast radio bearer in accordance with embodiments of the current invention. In one novel aspect, dynamic switch over from multicast to unicast is triggered by the switch over message from the network. An exemplary UE-1 has a multicast session and a unicast session with a gNB. gNB is configured with configuration 310 which includes a MRB 311 and a DRB-1 with UE-1. In one embodiment, the data packets for the MRB has SN for each PDCP PDU. The multicast PDCP PDUs are buffered for the MRB 311. gNB also tracks the ACK/NACK for the multicast data packets from UE-1. The gNB monitors and determines whether to switch over to a unicast mode for the multicast service destined to UE-1. In one embodiment, when the number of UEs receiving the multicast services is lower than a threshold value, the gNB determines to switch over from the multicast to unicast for the multicast service. At step 341, a Switch Over message is sent to the one or more UEs for the multicast service to switch over to the unicast mode. In embodiment 320, a temporary DRB is established for UE-1 to transmit the unacknowledged and buffered multicast data packets. Alternatively, in embodiment 330, a new DRB is established for both the new multicast data packets and the unacknowledged and buffered multicast data packets.

In one embodiment, MRB 321 is kept if there are one or more other UEs scheduled by multicast mode. The buffered data or the non-acknowledge data for UE-1, through step 351, is transmitted to UE-1 via unicast by a specific data pipe with DRB 322. Temporary unicast DRB 323 is established to transmit the new multicast data packet through step 352. DRB 322 is a temporary DRB established for UE-1 to transmit the buffered data and the non-acknowledged data for the multicast service to UE-1. The buffered data or the non-acknowledged data can be PDCP packets, RLC packets, or RLC segments, or any of their combinations. Temporary DRB 322 inherits the PDCP/RLC/MAC configurations from the MRB 311. Temporary DRB 322 is advantageous for transmitting the buffered RLC packets, and/or RLC segments by taking advantage of the exact same configuration of the PDCP/RLC/MAC configurations. Usually, when a new DRB is established, PDCP/RLC/MAC configurations are different from the MRB. The PDCP SN is re-numbered. The new RLC service data unit (SDU) and RLC SDU segments, or RLC PDU and RLC PDU segments, may have different PDCP configurations from the buffered or non-acknowledged new RLC SDU and RLC SDU segments, or RLC PDU and RLC PDU segments. In one embodiment, the corresponding temporary logical channel associated with temporary DRB 322 has the same LCID of MRB. In another embodiment, the corresponding temporary logical channel associated with temporary DRB 322 has different LCID of MRB is allocated. Both logical channel of temporary DRB 322 and logic channel of the new DRB 323 are subject to MAC layer multiplexing procedure at the base station. Both logical channel of temporary DRB 322 and new logic channel of the new DRB 323 are subject to MAC demultiplexing procedure at UE-1.

In another embodiment, as shown in 330, a new DRB 333 is established to transmit buffered data or the non-acknowledged data as well as the new PDCP packets for the multicast service. The buffered data or the non-acknowledge data for UE-1, through step 361, is transmitted to UE-1 via unicast by the newly established unicast DRB 333. New unicast DRB 333 also transmit the new multicast data packet through step 362. The PDCP PDU packet, or the PDCP SDU, with the lowest SN that has buffered RLC SDU, RLC SDU segments, RLC PDU, or RLC PDU segments are input into PDCP entity of the new unicast DRB 333 PDCP entity to perform unicast transmission to the UE. The PDCP entity of the new unicast DRB 333 provides continuous numbering of PDCP SN for the new PDCP packets. No temporary DRB is needed. The new unicast DRB 333 follows the same configuration of the MRB 311 in terms of PDCP/RLC/MAC configurations to ensure continued transmission of the buffered or non-acknowledged PDCP packets, RLC packets, and/or RLC segments. In one embodiment, the logical channel of new unicast DRB 333 is the same as the LCID of MRB 311. In another embodiment, the logical channel of new unicast DRB 333 is different from the LCID of MRB 311. In yet another embodiment, when new unicast DRB 333 completes the transmission of the buffered or non-acknowledged PDCP packets, RLC packets, and/or RLC segments, the base station enables new configuration via RRC Reconfiguration message. The logic channel of the new unicast DRB 333 is subject to MAC layer multiplexing procedure at the base station together with other unicast logical channels. The logic channel of the new unicast DRB 333 is subject to MAC demultiplexing procedure at UE together other unicast logical channels. New unicast DRB 333 prioritizes the transmission of the buffered or non-acknowledged PDCP packets, RLC packets, and/or RLC segments over new arrived multicast PDCP packets for the multicast service.

When the multicast-to-unicast switching is performed, the protocol stacks are established for the new unicast DRB and, optionally the temporary DRB. The same SDAP entity is used for the new unicast DRB after the switch at both base station and the UE. The same PDCP entity is reused at the UE. A new PDCP entity for unicast DRB is established at the base station. The security configuration is inherited from the MRB for this new unicast DRB in case of no temporary DRB configuration. When the temporary DRB is established to transmit the buffered MRB data or the non-acknowledged MRB data for the MRB to the UE, in one embodiment, the new unicast DRB inherits the security configuration from the MRB. In another embodiment, a different security configuration is configured for the new unicast DRB when a temporary DRB is configured. The base station notifies the UE through MAC CE or RRC message when using a different security configuration, or one or more different configurations, such as the PDCP configuration, the RLC configuration, and the MAC configuration.

In one embodiment, temporary DRB 322 is established to transmit the buffered or non-acknowledged data and a new PDCP entity for new unicast DRB may be established at the base station with a different unicast security configuration. The PDCP entity of the UE is reconfigured to support both UE specific unicast security configuration (such as the security configuration for unicast) and MRB common security configuration for the corresponding temporary DRB to seamlessly receive both the buffered or non-acknowledged data from temporary DRB 322 and new data packets from new unicast DRB 323. The reconfigured PDCP entity at UE uses different security configuration at PDCP layer during packet resolution for different data flows. Different data flows are identified by different LCIDs. In one embodiment, the same RLC entity is reused at UE after switch for MRB. In another embodiment, the UE RLC entity is reconfigured when a RRC Reconfiguration is received from the base station. A new RLC entity for the new unicast DRB is established at the base station.

There are two options for the MAC-config for logical channel configuration for the new established unicast DRB. In one embodiment, a new unicast traffic channel LCID is used. The base station notifies the UE the logical channel configuration during the multicast-to-unicast or unicast-to-multicast switch. In another embodiment, the same LCID is used for the new unicast traffic channel and the MRB LCID is inherited for the new unicast DRB. When a temporary DRB is configured the same LCID as the LCID for the MRB to transmit the buffered MRB data or unacknowledged MRB data, a new logical channel with different LCID is allocated for the new established unicast DRB sot that the UE can differentiate the temporary DRB and the new unicast DRB by the logical channel during data reception at MAC layer.

In other embodiments, the HARQ layer feedback, the RCL layer feedback, or the combination of them are used for reliability improvement using UL feedback. In one embodiment, the base station determines to trigger the multicast to unicast switch procedure for a multicast service to a UE based on the UL feedback. In one embodiment, the switch procedure is triggered upon determining that retransmission of the multicast data packets with the MRB would not ensure the successful reception at the UE. When HARQ layer only feedback is supported for UL feedback for multicast service, RLC UM mode is used for the MRB. The HARQ layer feedback is transmitted at PUCCH. No RLC retransmission is supported. For HARQ layer only feedback, the whole procedure can be described as the following. When RLC layer feedback is supported for UL feedback for multicast service, RLC AM mode is used for the MRB. The RLC layer feedback (i.e. RLC Status Report) is transmitted at PUSCH. RLC retransmission is supported.

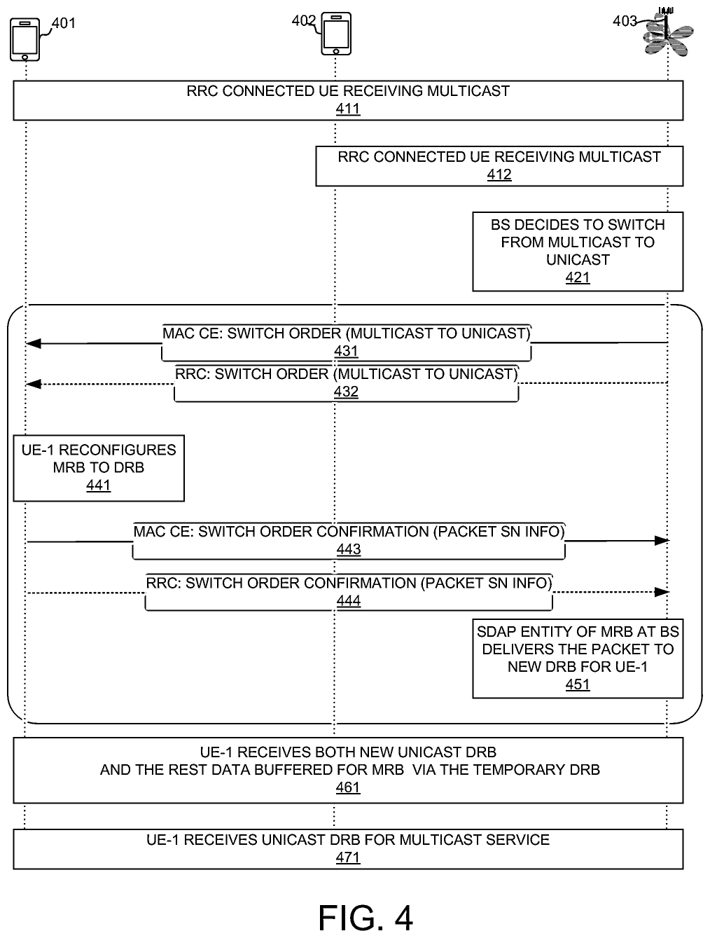

FIG. 4 illustrates exemplary flow diagrams for multicast-to-unicast signaling in accordance with embodiments of the current invention. The NR wireless network includes a UE1 401, a UE2 402, and a gNB/base station (BS) 403. At step 411, UE1 401 is RRC connected with gNB 403 and receives the multicast service via MRB. At step 412, UE1 402 is RRC connected with gNB 403 and receives the multicast service via MRB. At step 421, gNB 403 detects that there are one or more UEs not successfully receive the HARQ transmission and/or RLC transmission after the DL transmission reaches the maximum HARQ retransmission and/or RLC transmission. gNB 403 determines to move the multicast transmission to unicast transmission for UE1 401 for the multicast service. In one embodiment, gNB 403 determines to switch UE1 401 to unicast mode for the multicast service based on one or more predefined triggering events. The triggering event includes HARQ and/or RLC transmission and retransmission failure, the number of the UEs receiving the multicast service is lower than a predefined threshold. In one embodiment, the multicast services for one or more other UEs, such UE2 402, continues with the multicast via other MRBs. In another embodiment, gNB 403 decides to move the multicast transmission to unicast transmission, for all UEs for this multicast service according to other conditions based on one or more predefined triggering events.

In one embodiment, at step 431, gNB 403 sends a specific switch order in MAC-CE to UE1 401. In another embodiment, the switch order is sent in a specific RRC message, such as an RRC Reconfiguration. The switch order from gNB 403 notifies UE1 401 to switch from multicast to unicast. The contents of the switch order include one or more elements comprising a switch type, a previous LCID, and a new LCID. In another embodiment, when a temporary DRB is used to transmit the buffered MRB data or unacknowledged MRB data, the logical channel ID of this temporary DRB is also sent in this switch order. In case of RRC Reconfiguration, some additional configurations including the PDCP with security configuration, the RLC and MAC configuration are indicated to the UE for the new established unicast DRB, and/or temporary DRB. The security configuration of an associated ongoing DRB is indicated within the RRC Reconfiguration message to instruct UE1 401 to use the associated security configuration to receive the new PDCP packets. In one embodiment, the key derivation information is included for vertical or horizontal key derivation for this new unicast DRB. Upon sending the switch over, gNB 401 starts to establish a new unicast DRB to replace the MRB including PDCP/RLC/logic channel configuration. In one embodiment, the new PDCP entity uses the security configuration of the MRB. In another embodiment, the new PDCP entity uses the security configuration of an associated ongoing DRB. When a temporary DRB is used to transmit the buffered MRB data or unacknowledged MRB data from gNB 403 to UE1 401, gNB 403 starts to establish this temporary DRB with same PDCP/RLC/MAC configuration inherited from MRB. The LCID for this temporary DRB may be the same as MRB or different from the MRB. Upon receiving the switch order from gNB 403, At step 441, UE 401 prepares the reconfiguration of the MRB and the corresponding PDCP and RLC entities and logic channel at the MAC layer. In one embodiment, an additional mapping between the new unicast LCID and the PDCP/RLC entities for data reception is created. UE1 401 receives the buffered or unacknowledged MRB data from gNB 403 via the same MRB LCID or a different LCID for the temporary DRB or the newly established unicast DRB based on the configuration. In one embodiment, new security configuration is applied to the newly established unicast DRB.

At step 443, upon finishing the reconfiguration, UE1 401 send a switch order confirmation with SN information to gNB 403. In another embodiment, the switch order confirmation is sent via an RRC message, such as an RRC Reconfiguration Complete message. The SN information is an SN of the last received RLC packet, or the SN of the next RLC packet expected to receive. In another embodiment, the SN information is the SN of last received PDCP packet, or the SN of the next PDCP packet expected to receive. In yet another embodiment, the SN information is the last received RLC segments, or the numbering of the next RLC segments expected to receive. Any combinations of the SN information are allowed. The PDCP packet, RLC packet, RLC segments can be both PDU based or SDU based. In one embodiment, an RLC Status Report like contents are sent to the BS via MAC-CE, or RRC message as an acknowledgement of the switch order. The contents include the SN range of the received RLC PDU, the SN range of the non-received RLC packets, segments information of the received RLC packets, segments information of the non-received RLC packets, or any their combinations. In another embodiment, the RLC Status Report like contents are piggybacked onto an existing unicast DRB at uplink. Alternatively, it is transmitted at the established unicast DRB at Uplink, when UE1 401 adds the newly established unicast DRB logical channel into the LCP and multiplex it at the MAC entity together with other logical channels. The newly established unicast DRB is configured with RLC AM. The uplink transmission is only for the RLC feedback, such as the RLC Status Report.

At step 451, the SDAP entity of the MRB at gNB 403 stops delivering multicast data packets to lower layers of MRB when all related UEs are switched from multicast to unicast. Otherwise, the SDAP entity delivers the data flow to both unicast PDCP entity and multicast PDCP entity simultaneously. When multiple UEs are switched from multicast to unicast, this multicast SDAP entity delivers the data flow to all PDCP entities corresponding to the DRBs established for unicast transmission for the multicast service. gNB 403 keeps multiple mappings between the SDAP entity and PDCP entities. In one embodiment, the first PDCP SN for the new packet on the new established unicast DRB PDCP entity is the last PDCP SN assigned by the MRB PDCP entity plus one. In another embodiment, gNB 403 sends an end marker PDCP control PDU at the MRB PDCP to indicate the switch. The same PDCP SN length is reused after the switch. Alternatively, the SN of the new established unicast DRB PDCP entity starts from zero.

At step 461, UE1 401 receives both new unicast DRB and the rest buffered data for MRB via the temporary unicast DRB. When a temporary DRB is used to transmit the buffered MRB data or unacknowledged MRB data, gNB 403 adds the temporary DRB logical channel into the multiplexing procedure at MAC entity and multiplexes the temporary DRB logical channel together with all other unicast logical channel until the transmission finishes for the buffered MRB data or unacknowledged MRB data. The MAC layer of UE1 401 performs simultaneous reception of buffered MRB data or unacknowledged MRB data, and unicast DRB packets for the switched multicast services. It is indicated by different LCID within sub-header of the MAC sub-PDU. At step 471, UE1 401 receives the multicast service from the unicast DRB. The transmission for buffered MRB data or unacknowledged MRB data is complete. UE1 401 only receives unicast DRB for the multicast service. The additional unicast may be still ongoing. The MRB is sent over MTCH scheduled by G-RNTI without the MAC multiplexing/demultiplexing process. After the switch, the MRB is scheduled by PDCCH with C-RNTI, the same as for the unicast DRB.

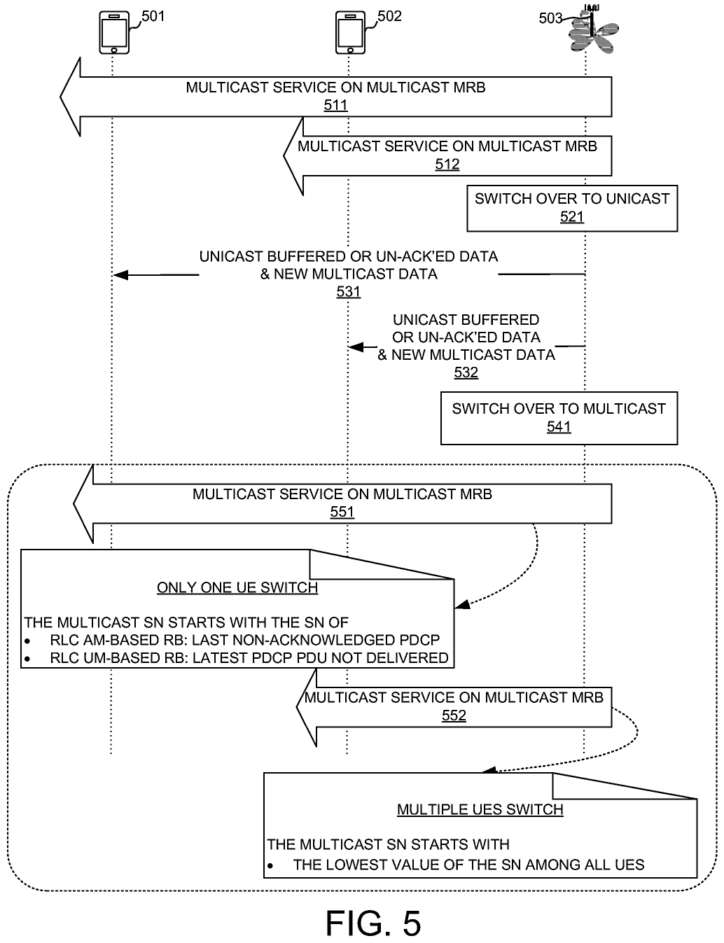

FIG. 5 illustrates exemplary flow diagrams for unicast-to-multicast signaling in accordance with embodiments of the current invention. The NR wireless network includes a UE 501, a UE 502, and a gNB 503. At step 511 UE 501 receives the multicast service from gNB 503 through the MRB. At step 512 UE 502 receives the multicast service from gNB 503 through the MRB. At step 521, gNB 503 determines to switch from multicast to unicast for the multicast service. At step 531, gNB 503 sends buffered and/or unacknowledged data as well the new multicast data packets to UE 501 via unicast DRB. Similarly, at step 532, gNB 503 sends buffered and/or unacknowledged data as well the new multicast data packets to UE 502 via unicast DRB. At step 541, gNB 503 determines to switch from unicast to the multicast mode for the unicast service. gNB 503 sends switch order to UE 501 and UE 502, via MAC CE or RRC message of RRC Reconfiguration, indicating to switch from unicast to multicast. At step 551, gNB 503 transmits the multicast service on multicast MRB to UE 501. At step 552, gNB 503 transmits the multicast service on multicast MRB to UE 502. When the multicast service switches from the unicast to the multicast switch, the multicast starts with the SN of last non-acknowledged PDCP packet for RLC AM mode-based radio bearer. For RLC UM mode-based radio bearer, the multicast starts with the SN of the latest PDCP packet that is not delivered by RLC entity. In case of multiple UE switches, such as at step 552, when both UE 501 and UE 502 switch from unicast to multicast, the starting SN of the PDU for MRB is based on the lowest value of the SN among all switched UEs. The same PDCP/RLC uses the same configuration. A common multicast logical channel replaces the multiple unicast logical channels for multiple switched UEs. The switch order using MAC CE or RRC Reconfiguration message indicates the switch type being from unicast to multicast. The new LCID for the multicast logic channel is included in the switch order. In one embodiment, the switch order triggers a RLC status report sent from the UE to the gNB, through the RLC AM mode-based unicast DRB, indicating the next packet expected via MRB.

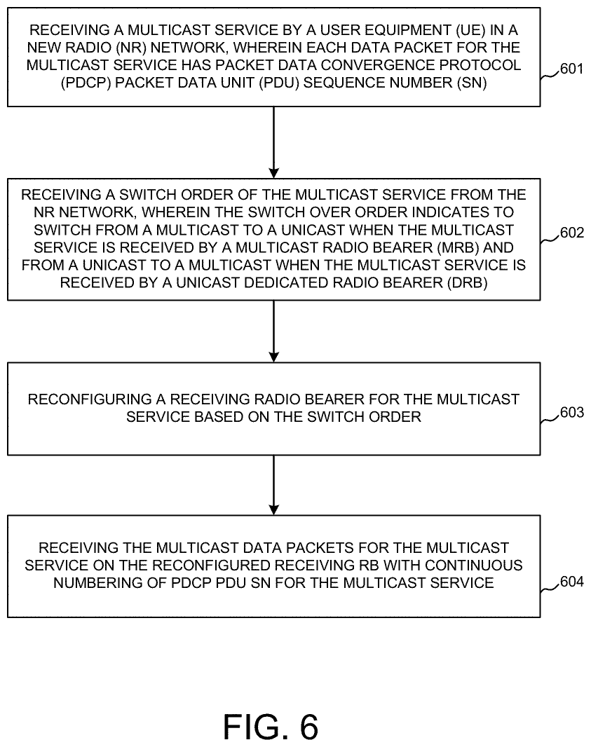

FIG. 6 illustrates an exemplary flow chart of the UE performing the dynamic switch between the multicast and the unicast for NR multicast services in accordance with embodiments of the current invention. At step 601, the UE receives a multicast service in a NR network, wherein each data packet for the multicast service has PDCP PDU sequence number (SN). At step 602, the UE receives a switch order of the multicast service from the NR network, wherein the switch over order indicates to switch from a multicast to a unicast when the multicast service is received by a multicast radio bearer (MRB) and from a unicast to a multicast when the multicast service is received by a unicast dedicated radio bearer (DRB). At step 603, the UE reconfigures a receiving radio bearer for the multicast service based on the switch order. At step 604, the UE receives the multicast data packets for the multicast service on the reconfigured receiving RB with continuous numbering of PDCP PDU SN for the multicast service.

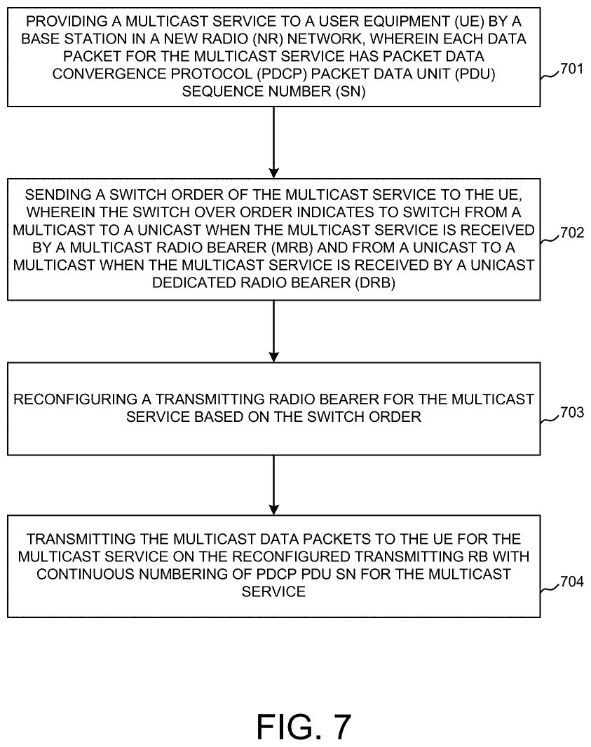

FIG. 7 illustrates an exemplary flow chart of the base station/gNB performing the dynamic switch between the multicast and the unicast for NR multicast services in accordance with embodiments of the current invention. At step 701, the gNB provides a multicast service to a user equipment (UE) by a base station in a new radio (NR) network, wherein each data packet for the multicast service has packet data convergence protocol (PDCP) packet data unit (PDU) sequence number (SN). At step 702, the gNB sends a switch order of the multicast service to the UE, wherein the switch over order indicates to switch from a multicast to a unicast when the multicast service is received by a multicast radio bearer (MRB) and from a unicast to a multicast when the multicast service is received by a unicast dedicated radio bearer (DRB). At step 703, the gNB reconfigures a transmitting radio bearer for the multicast service based on the switch order. At step 704, the gNB transmits the multicast data packets to the UE for the multicast service on the reconfigured transmitting RB with continuous numbering of PDCP PDU SN for the multicast service.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a multicast service by a user equipment (UE) in a new radio (NR) network, wherein each data packet for the multicast service has packet data convergence protocol (PDCP) packet data unit (PDU) sequence number (SN);
receiving a switch order of the multicast service from the NR network, wherein the switch over order indicates to switch from a multicast to a unicast when the multicast service is received by a multicast radio bearer (MRB) and from a unicast to a multicast when the multicast service is received by a unicast dedicated radio bearer (DRB);
reconfiguring a receiving radio bearer for the multicast service based on the switch order; and
receiving the multicast data packets for the multicast service on the reconfigured receiving RB with continuous numbering of PDCP PDU SN for the multicast service.

2. The method of claim 1, wherein the switch order indicates to switch from multicast to unicast for the multicast service, and wherein a new unicast DRB is established for the multicast service.

3. The method of claim 2, wherein the switch order is a MAC control element (CE) of switch over including one or more elements comprising a switch type, a logic channel identification (LCID) of the MRB, an LCID of the unicast DRB, and an LCID of a temporary DRB.

4. The method of claim 3, wherein the UE acknowledges the switch order by a specific MAC CE of switch order confirm including information of a next expected data packet of one or more data types comprising a PDCP PDU, a RLC PDU, and a RLC segment.

5. The method of claim 2, wherein the switch order is a radio resource control (RRC) message of switch order including one or more elements comprising a switch type, a logic channel identification (LCID) of the MRB, an LCID of the unicast DRB, an LCID of a temporary DRB, and security configuration of the new unicast DRB.

6. The method of claim 5, wherein the UE acknowledges the switch order by a RRC message of switch order confirm including information of a next expected data packet of one or more data types comprising a PDCP PDU, a RLC PDU, and a RLC segment.

7. The method of claim 2, wherein the new unicast DRB receives unacknowledged and buffered multicast data packets for the MRB and new multicast data packets for the unicast DRB.

8. The method of claim 1, wherein the switch order indicates to switch from unicast to multicast for the multicast service, and wherein a new MRB is established for the multicast service.

9. The method of claim 8, wherein the new MRB starts with a multicast data packet with an SN of a last non-acknowledged PDCP packet.

10. The method of claim 2, wherein multiple UEs are switched to multicast for the multicast service, the new MRB starts with a multicast data packet with an SN of a lowest value among all UEs switched for the multicast service.

11. A method comprising:
providing a multicast service to a user equipment (UE) by a base station in a new radio (NR) network, wherein each data packet for the multicast service has packet data convergence protocol (PDCP) packet data unit (PDU) sequence number (SN);
sending a switch order of the multicast service to the UE, wherein the switch over order indicates to switch from a multicast to a unicast when the multicast service is received by a multicast radio bearer (MRB) and from a unicast to a multicast when the multicast service is received by a unicast dedicated radio bearer (DRB);
reconfiguring a transmitting radio bearer for the multicast service based on the switch order; and
transmitting the multicast data packets to the UE for the multicast service on the reconfigured transmitting RB with continuous numbering of PDCP PDU SN for the multicast service.

12. The method of claim 11, The method of claim 1, wherein the switch order indicates to switch from multicast to unicast for the multicast service, and wherein a new unicast DRB is established for the multicast service.

13. The method of claim 12, wherein the new unicast DRB transmits buffered multicast data packets, unacknowledged multicast data packets, and new multicast data packets.

14. The method of claim 12, wherein a temporary DRB is established for buffered multicast data packets, unacknowledged multicast data packets.

15. The method of claim 14, wherein the temporary DRB has a same logic channel ID (LCID) as the MRB and the new unicast DRB has a different LCID from the MRB.

16. A user equipment (UE), comprising:
a transceiver that transmits and receives radio frequency (RF) signal in a new radio (NR) wireless network;
a multicast service handler that receives a multicast service by a user equipment (UE) in a new radio (NR) network, wherein each data packet for the multicast service has packet data convergence protocol (PDCP) packet data unit (PDU) sequence number (SN);
a switch order handler that receives a switch order of the multicast service from the NR network, wherein the switch over order indicates to switch from a multicast to a unicast when the multicast service is received by a multicast radio bearer (MRB) and from a unicast to a multicast when the multicast service is received by a unicast dedicated radio bearer (DRB);
a reconfiguration handler that reconfigures a receiving for the multicast service based on the switch order; and
an SN handler that receives the multicast data packets for the multicast service on the reconfigured receiving RB with continuous numbering of PDCP PDU SN for the multicast service.

17. The UE of claim 16, wherein the switch order indicates to switch from multicast to unicast for the multicast service, and wherein a new unicast DRB is established for the multicast service.

18. The UE of claim 17, wherein the switch order is one message type selecting from a MAC control element (CE) of switch over and a radio resource control (RRC) message, and wherein the switch order including one or more elements comprising a switch type, a logic channel identification (LCID) of the MRB, an LCID of the unicast DRB, an LCID of a temporary DRB, and security configuration of the new unicast DRB.

19. The UE claim 18, wherein the UE acknowledges the switch order by switch order confirm with a message selecting one from a MAC CE and a RRC message, and wherein the switch order confirm message includes information of a next expected data packet of one or more data types comprising a PDCP PDU, a RLC PDU, and a RLC segment.

20. The UE of claim 17, wherein the new unicast DRB receives unacknowledged and buffered multicast data packets for the MRB and new multicast data packets for the unicast DRB.
